(19) United States
(12) Patent Application Publication
(10) Pub. No.: US 2025/0341466 A1
(43) Pub. Date: Nov. 6, 2025

(54) A METHOD FOR TRANSPORT OF INTENSITY DIFFRACTION TOMOGRAPHY WITH NON-INTERFEROMETRIC SYNTHETIC APERTURE

(71) Applicant: Nanjing University of Science and Technology, Nanjing, Jiangsu (CN)

(72) Inventors: Chao ZUO, Nanjing (CN); Qian CHEN, Nanjing (CN); Jiasong SUN, Nanjing (CN); Shijie FENG, Nanjing (CN); Shun ZHOU, Nanjing (CN); Yao FAN, Nanjing (CN); Linpeng LU, Nanjing (CN); Yuzhen ZHANG, Nanjing (CN)

(73) Assignee: Nanjing University of Science and Technology, Nanjing, Jiangsu (CN)

(21) Appl. No.: 18/860,312

(22) PCT Filed: Apr. 23, 2023
(86) PCT No.: PCT/CN2023/090075

§ 371 Date: Jul. 25, 2025

(30) Foreign Application Priority Data
May 19, 2022 (CN) 202210545129.5

(51) Int. Cl. G01N 21/47; G02B 27/58

(52) U.S. Cl. CPC G01N 21/4788; G01N 21/4795; G02B 27/58

(57) ABSTRACT

This invention discloses a method for transport of intensity diffraction tomography based on non-interferometric synthetic aperture. By acquiring through-focus intensity stacks under different illumination angles and performing three-dimensional Fourier domain half-space filtering (or 3D Hilbert transform equivalently) on the measured intensity stack, further combining with non-interferometric synthetic aperture, the 3D refractive index tomographic imaging in a non-interferometric manner without the need to meet matched illumination condition can be achieved. Leveraging the inherent advantage of synthetic aperture, the imaging resolution reaches the incoherent diffraction limit, resulting in high-resolution imaging results. The non-interferometric nature of TIDT-NSA offers a simple imaging optical setup, delivers speckle-free imaging quality, and is compatible with an off-the-shelf bright-field microscope.

### TECHNICAL FIELD

This invention belongs to optical microscopy measurement and 3D RI imaging technique, particularly a method for transport of intensity diffraction tomography with non-interferometric synthetic aperture.

### BACKGROUND

In the field of biomedical microscopic imaging, most living cells and unstained biological specimens are colorless and transparent, because the refractive indices and thicknesses of the subtle structures within the cell differ; when light waves pass through, neither wavelength nor amplitude changes, only the phase changes, yet such phase differences cannot be observed by the human eye. Therefore, it is necessary to render cells visible under the microscope by means of certain chemical or biological approaches such as staining or labeling. Over the past several decades, a variety of fluorescence microscopic imaging modalities—wide-field, confocal, total internal reflection fluorescence, two/multi-photon, and light-sheet fluorescence microscopy—have been developed. These techniques serve as powerful tools for detecting extremely weak signals and for revealing the 3D structure and functional characteristics of fixed or living cells, offering high specificity. In these techniques, fluorescent labels attached to specific molecular structures are excited by short-wavelength lasers and subsequently emit longer-wavelength fluorescence, thereby enabling imaging of originally transparent biological samples. Since the beginning of the twenty-first century, super-resolution fluorescence microscopy has broken the diffraction limit, improving imaging resolution to the order of tens of nanometers and providing technical means for studies at the subcellular scale. Current super-resolution fluorescence imaging methods include stimulated emission depletion microscopy (STED), structured illumination microscopy (SIM), stochastic optical reconstruction microscopy (STORM), and photo-activated localization microscopy (PALM). However, these techniques are not suitable for imaging non-fluorescent samples or for visualizing cellular components that cannot be labeled with fluorescent molecules, thereby restricting the application scope of fluorescence microscopy. In addition, exogenous fluorophores can induce phototoxicity that may irreversibly compromise cellular viability and other cellular functions, and the associated photobleaching precludes long-term imaging of living cells over extended periods.

In recent years, in order to simplify sample preparation, eliminate the interference of fluorescent molecules on the specimen, and satisfy clinical imaging demands, label-free optical imaging has become a focal point in biomedical microscopic research. Phase-contrast microscopy employs refractive index as an intrinsic optical imaging contrast and enables label-free imaging of biological samples without exogenous labeling agents. Among these, 2D label-free imaging merely records the accumulated optical absorption or optical path difference of the object along the axial direction; the refractive index and thickness information that reflect sample properties are coupled and cannot be disentangled, preventing acquisition of 3D information. To obtain more accurate morphological parameters—such as volume, shape, and dry mass, label-free 3D imaging of biological specimens has emerged as a prominent direction of current research.

The introduction of optical interferometry and holography into microscopy made it possible to measure tiny phase differences induced by the specimens, facilitating the evolution of phase imaging techniques from qualitative observation to quantitative measurement. By combining optical holography with computed tomography, through either object rotation or illumination scanning, various types of ODT have been developed to infer the volumetric RI distribution of biological specimens, extending QPI to 3D. In particular, ODT enables 3D label-free microscopy and has been successfully applied to investigate various types of biological specimens, including blood cells, neuron cells, cancer cells, and bacteria. Nevertheless, due to the temporally coherent illumination typically used, these coherent QPI and ODT methods suffer from speckle noise that prevents the formation of high-quality images. Moreover, most of them require a specialized interferometric setup with complicated beam scanning devices, hindering their widespread adoption in the biological and medical communities.

To address the shortcomings and deficiencies of ODT based on interferometric measurements and promote the application of 3D RI imaging in the biomedical field, various diffraction tomography techniques based on non-interferometric measurements have gradually developed. These methods rely solely on the intensity of the scattered light captured by the camera, forfeiting phase information. Consequently, for both 2D QPI and 3D diffraction tomography, accurate recovery of phase or RI necessitates matched illumination condition, where the numerical aperture (NA) of the illumination matches that of the objective lens. However, it is difficult to strictly fulfill the matched illumination condition in experiments, especially for high-NA imaging systems. Failure to meet the matched illumination condition precludes the intact recovery of the phase component due to the low-frequency spectral overlapping in the captured intensity, bringing a daunting challenge to asymmetric-illumination-based non-interferometric diffraction tomography with high-NA objectives. Thus, devising strategies to bypass the stringent matched illumination condition, enabling non-interferometric diffraction tomography under arbitrary illumination, and achieving precise 3D RI recover, presents a formidable technical hurdle.

### Invention Content

The purpose of this invention is to provide a method for transport of intensity diffraction tomography with non-interferometric synthetic aperture (TIDT-NSA). The steps are as follows:

Step 1: Collect through-focus intensity stacks of the object under different illumination angles by turning on each LED element sequentially;

Step 2: Calculate corresponding 3D spectra by taking 3D Fourier transform on the logarithmic intensity stack, by implementing the 3D half-space Fourier filtering on each logarithmic 3D intensity spectrum, the corresponding 3D scattered fields (containing real and imaginary parts of complex phase function) under different incident illuminations can be retrieved, the preliminary estimate of the 3D object spectrum can be further got by synthesizing 3D scattered fields together;

Step 3: Perform 3D deconvolution on the preliminarily estimated spectrum based on LED discrete sampling, partially coherent illumination, and a correction factor.

Step 4: Employ a hybrid iterative constraint algorithm combining non-negative constraint and total-variation regularization to computationally fill the missing-cone information in the synthesized scattering-potential spectrum.

Step 5: Perform a 3D inverse Fourier transform on the filled 3D scattering-potential spectrum to reconstruct the 3D refractive-index distribution of the sample, thereby realizing non-invasive 3D imaging of label-free biological specimens.

Preferably, acquire axial defocus intensity stacks under different illumination angles using an intensity-transport diffraction tomographic microscopy platform based on non-interferometric synthetic aperture; the said intensity-transport diffraction tomographic microscopy platform comprises a programmable LED array, motorized-stage scanning device, specimen under test, microscope objective, imaging tube lens, and camera; the center of the programmable LED array coincides with the optical axis of the microscope objective and is placed at a set distance from the specimen; the back focal plane of the microscope objective overlaps the front focal plane of the tube lens; the imaging plane of the camera is positioned at the back focal plane of the imaging tube lens; during imaging, the specimen is mounted on the motorized stage; LED units are illuminated sequentially; quasi-monochromatic plane waves illuminate the specimen under test, pass through the objective, converge after the imaging tube lens, and fall onto the imaging plane of the camera; by controlling axial scanning of the motorized stage, the camera records a 3D intensity stack.

Preferably, in Step 2 take the logarithm of the 3D intensity stacks under different incident illuminations and perform a 3D Fourier transform to obtain the 3D logarithmic intensity spectrum.

Preferably, adopt the scattering potential function O(r) to characterize the 3D structure of the specimen; expand the scattering potential function O(r) into real and imaginary parts, namely O(r)=a(r)+jϕ(r), where ϕ(r) and a(r) correspond to the phase component and absorption component of the scattering potential O(r).

The logarithm of the 3D intensity stack I(r) under different illumination conditions is taken and expressed as:

$$ln I ( r ) = a ( r ) ⊗ [ {g}^{′} ( r ) + {g}^{′ *} ( r ) ] + j ϕ ( r ) ⊗ [ {g}^{′} ( r ) - {g}^{′ *} ( r ) ] \qquad ( 1 )$$

where ϕ(r) and a(r) correspond to the phase and absorption components of the scattering potential O(r), respectively. g(r) and g′(r) represent the point spread function (PSF) of the tomographic imaging system and the PSF modulated by the incident illumination Uᵢₙ(r), respectively. g*(r) is the conjugate form of g′(r).

By computing the Fourier transform of the above equation, the logarithmic intensity spectrum function is obtained as:

$$ln \hat{I} ( u ) = {H}_{a} ( u ) \hat{a} ( u ) + {H}_{ϕ} ( u ) \hat{ϕ} ( u ) \qquad ( 2 )$$

where Î(u), â(u) and \hat{ϕ}(u) correspond to the 3D Fourier transforms of the intensity stack I(r), the absorption component a(r), and the phase component ϕ(r) of the scattering potential O(r), respectively. Hₐ(u) and H_{ϕ}(u) are the absorption and phase transfer functions of the diffraction tomography imaging system.

Preferably, the absorption and phase transfer functions of the diffraction-tomography imaging system are expressed respectively as:

$${H}_{a} ( u ) = [ P ( u + {u}_{i n} ) + {P}^{*} ( u - {u}_{i n} ) ] \qquad ( 3 )$$

$${H}_{ϕ} ( u ) = j [ P ( u + {u}_{i n} ) - {P}^{*} ( u - {u}_{i n} ) ]$$

where

$$P ( u ) = P ( {u}_{T} ) δ ( {u}_{z} - \sqrt{{u}_{m}^{2} - {\vert {u}_{T} \vert}^{2}} )$$

is the generalized coherent transfer function of the system; u=(u_{T}, u_{z}) is the spatial frequency coordinates corresponding to r, uₘ=nₘ/λ with nₘ being the refractive index of the medium surrounding the sample and λ the wavelength in free space. P*(u) is the complex conjugate of P(u), P(u+uᵢₙ) and P*(u−uᵢₙ) represent the phase transfer functions of P(u) and P*(u), respectively, after being laterally modulated by the incident spatial frequency uᵢₙ.

Preferably, the concrete process of performing 3D half-space Fourier filtering or a 3D Hilbert transform on each logarithmic intensity spectrum to obtain 3D scattering fields containing the real and imaginary parts of the complex phase function under different incident illuminations, synthesizing all single-sideband 3D scattering fields in Fourier space to realize non-interferometric synthetic aperture, and obtaining a preliminary estimate of the sample's 3D scattering potential spectrum is as follows:

According to the positions of the two antisymmetric generalized apertures in the spectrum, each double-sideband 3D spectrum is processed using 3D half-space Fourier filtering or a 3D Hilbert transform to obtain the 3D scattering field Uₛ₁(r) under different illumination conditions, which contains both the real and imaginary parts of the complex phase function. This is based on the Fourier diffraction theorem.

$$\hat{O} ( u - {u}_{i n} ) = 4 π {ju}_{z} {\hat{U}}_{sl} ( {u}_{T} ) P ( {u}_{T} ) δ ( {u}_{z} - \sqrt{{u}_{m}^{2} - {\vert {u}_{T} \vert}^{2}} ) \qquad ( 4 )$$

In the Fourier domain, all single-sideband 3D scattering fields are synthesized to achieve non-interferometric synthetic aperture, yielding an initial estimate of the 3D scattering potential spectrum of the object. In the equation, u=(u_{T}, u_{z}) represents the spatial frequency coordinates corresponding to r, j is the imaginary unit, and Ô and Ûₛ₁ denote the Fourier transforms of O and U_{S1}, respectively. Ô(u−uᵢₙ) is the scattering potential spectrum of Ô(u) modulated by the spatial frequency uᵢₙ of the incident light, and

$$P ( {u}_{T} ) δ ( {u}_{z} - \sqrt{{u}_{m}^{2} - {\vert {u}_{T} \vert}^{2}} )$$

is the system's generalized coherent transfer function, whose finite support domain is called the Ewald sphere shell.

Preferably, the deconvolution process in Step 3 is expressed as:

$$\hat{O} = \frac{{\hat{O}}_{syn} {H}_{syn}^{*}}{{H}_{syn} {H}_{syn}^{*} + ε} \qquad ( 5 )$$

where Ô and Ô_{syn} are the finally deconvolved spectrum of object scattering potential and preliminary synthesized spectrum, respectively, H_{syn} is the synthesized 3D transfer function of the system. H*_{syn} is the conjugate form of H_{syn}, and ε is regularization parameter.

Preferably, the 3D incoherent transfer function of the system after synthetic-aperture processing is specifically:

$${H}_{syn} ( {u}_{T} , {u}_{z} ) = \frac{j λ}{4 π} \int \int P ( {u}_{T}^{′} + {u}_{T} ) S ( {u}_{T}^{′} ) δ [ {u}_{z} + \sqrt{{λ}^{- 2} - {( {u}_{T}^{′} - {u}_{T} )}^{2}} ] {d}^{2} {u}_{T}^{′} \qquad ( 6 )$$

where j is the imaginary unit, λ is the illumination wavelength in free space, P(u_{T}) represents the objective pupil function, that is, the 2D coherent transfer function, which ideally is a circular function with a radius of NA_{obj}/λ, determined by the numerical aperture NA_{obj} of the objective; u=(u_{T}, u_{z}) is the spatial frequency coordinate corresponding to r; u_{T}=(uₓ, u_{y}) is the 2D spatial frequency coordinate, and S is the spatial frequency intensity distribution function of the illumination source.

This invention has significant advantages over the prior art:

1. The diffraction tomography based on non-interferometric measurement eliminates the need to introduce complex and unstable interferometric optical paths and devices, making the experimental setup simple and easy to combine with conventional bright-field microscopy.

2. The use of an LED source to provide quasi-monochromatic illumination improves imaging quality by avoiding the speckle noise and parasitic interference associated with laser sources.

3. This invention extends the intensity transport from “2D planar transport” to “3D volumetric transport”. By implementing 3D half-space Fourier filtering or equivalent Hilbert transform on logarithmic intensity spectra, the complex phase of scattered fields can be obtained with the intensity-only measurement. Ultimately, diffraction tomography with intensity-only measurement without the need for matched illumination condition is achieved, and the 3D RI of the sample is correctly recovered.

4. Synthetic aperture synthesizes the first-order scattered fields at different illumination angles in the 3D spectral space, expanding the spectral information accessible to the sample and significantly enhancing the imaging resolution and optical slicing capability. For example, under a 40×0.95 NA objective, the system's full-width lateral resolution is 330 nm and its axial resolution is 1.58 μm; under a 100×1.4 NA oil immersion objective, the system's full-width lateral resolution reaches 206 nm and its axial resolution reaches 0.52 μm.

5. By downsampling the illumination angles and the number of z-step slices, this invention can shorten the data acquisition time and achieve rapid and long-term imaging of dynamic samples.

This invention will be further described in detail with reference to the accompanying Figures.

### ATTACHED FIGURES DESCRIPTION

FIG. 1 is a flowchart of the method for transport of intensity diffraction tomography with non-interferometric synthetic aperture.

FIG. 2 is a schematic diagram of the illumination system for TIDT-NSA, as well as a synchronous block diagram of the hardware platform and electromechanical system.

FIG. 3 is the data acquisition period synchronization time series for TIDT-NSA.

FIG. 4 is the analytical analysis of 2D and 3D spectra under different illumination NA.

FIG. 5 is the data processing flowchart for 3D RI reconstruction using the TIDT-NSA, taking unstained MCF-7 cells as an example.

### SPECIFIC IMPLEMENTATION

The concept of this invention is a method for transport of intensity diffraction tomography based on non-interferometric synthetic aperture. By acquiring through-focus intensity stacks under different illumination angles and performing 3D Fourier domain half-space filtering (or 3D Hilbert transform equivalently) on the measured intensity stack, further combining with non-interferometric synthetic aperture, the 3D RI tomographic imaging in a non-interferometric manner without the need to meet matched illumination condition can be achieved. Leveraging the inherent advantage of synthetic aperture, the imaging resolution reaches the incoherent diffraction limit, resulting in high-resolution imaging results. The non-interferometric nature of TIDT-NSA offers a simple imaging optical setup, delivers speckle-free imaging quality, and is compatible with an off-the-shelf bright-field microscope.

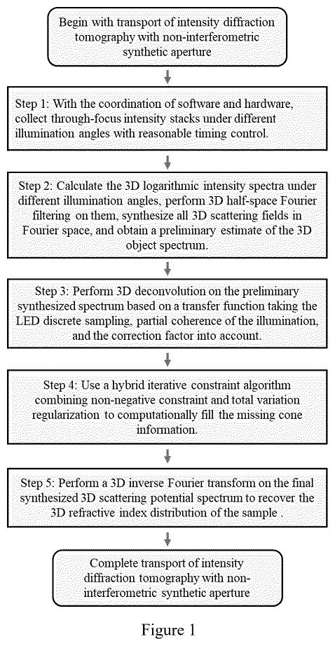

As shown in FIG. 1, the working flow of TIDT-NSA consists of the following steps:

Step 1: Collect through-focus intensity stacks of the object under different illumination angles.

In this step, a synchronization paradigm is designed, which efficiently coordinated the LED illumination pattern switch, focus stage movement, and camera readout interval, enabling fine and stable acquisition of through-focus intensity stacks at different illumination angles.

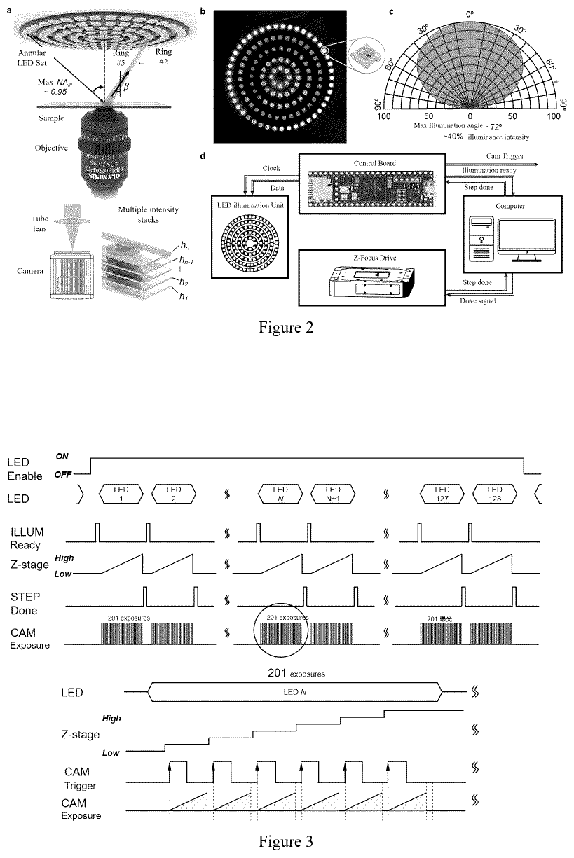

The specific implementation process is as follows: the present invention is based on intensity-transport diffraction tomographic microscopic imaging system of non-interferometric synthetic aperture, the actual hardware platform of the system includes programmable LED array (for example programmable multi-ring LED array), motorized stage scanning device, specimen under test, microscope objective, imaging tube lens and camera. As shown in FIG. 2, illumination system schematic diagram of the imaging platform as well as an example of hardware platform and electromechanical system synchronization block diagram are given. In the example programmable multi-ring LED array totally includes 128 LED units, distributed respectively on five concentric rings of different radii, equally spaced on each ring. Each LED unit is red, green and blue tricolor LED unit, whose typical wavelengths are red 629 nm, green 520 nm and blue 483 nm. The multi-ring LED array does not need separate fabrication, generally can be purchased directly on the market, Table 1 gives product parameters of a commercially available LED array.

TABLE 1
Product parameters of programmable annular LED array

| project | parameter | |
|---|---|---|
| LED unit model | WS2812B, SMD-5050 | |
| LED unit wavelength | Red 629 nm, green 520 nm, blue 483 nm | |
| LED unit bandwidth | ~20 | nm |
| Number of LED units | 128 | |
| LED unit power | ~200 | mW |
| Power source | 5 | V |

The center of the multi-ring LED array coincides with the optical axis of the microscope objective, placed at a distance of 25 mm from the sample, providing quasi-monochromatic plane-wave illumination with variable illumination angles up to approximately 72°, corresponding to a maximum illumination numerical aperture of 0.95. The back focal plane of the microscope objective overlaps the front focal plane of the tube lens; the imaging plane of the camera is located at the back focal plane of the imaging tube lens. During imaging, the sample is mounted on the motorized stage; LED units are sequentially illuminated; quasi-monochromatic plane waves illuminate the specimen under test, pass through the objective, converge after the imaging tube lens, and fall onto the imaging plane of the camera; by controlling axial scanning of the motorized stage, the camera records a 3D intensity stack.

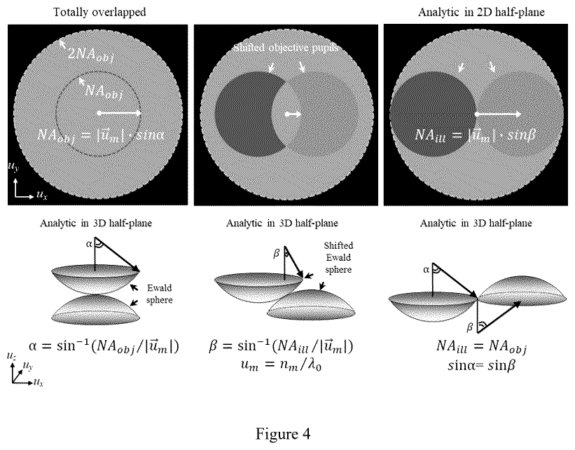

Each LED unit in the LED array can be individually switched on, controlled sequentially by a hardware control circuit (e.g., an ARM control board). Data-acquisition computer software communicates via programming interfaces and programs with the camera and the motorized stage; the camera and the LED array, through the same controller, use two coaxial cables for synchronization, providing trigger and exposure-status monitoring; the hardware control circuit supplies a series of trigger signals for camera triggering. Under a given illumination angle, software (e.g., μ-Manager) controls the high-precision motorized stage to scan different focal planes; this software, in USB-slave mode, synchronously transmits drive signals and step-completion marks with the hardware control circuit. To minimize acquisition time, the method employs a precise timing sequence to synchronize motorized stage motion and camera exposure; using the camera's external trigger mode combined with the hardware control circuit, the switching of LED illumination is synchronized with row exposure. The cyclic synchronization timing sequence among LED illumination mode switching, motorized stage axial scanning, and camera readout is shown in FIG. 4. Because each intensity-stack exposure sequence is synchronized with LED angular illumination, this scheme is equivalent to operating in global-shutter mode. Additionally, by reducing the effective exposure time (e.g., controlling exposure time around 50 ms), vibration noise and time-varying motion artifacts are minimized. To avoid variations in actual exposure time and instability in the initial state of the focus-scanning stage, the method introduces a delay before acquiring a new intensity stack.

For long-term imaging of dynamic samples, the method can reduce the resistance of the current-limiting resistor to provide sufficient total photon flux under the same exposure time. By down-sampling illumination angles and the number of z-axis defocus slices, data acquisition time is shortened to reach the system's imaging speed limit to meet the imaging requirements for dynamic samples. For example, within 20 seconds it can capture intensity stacks under 12 different illumination angles containing at least 15 different axial displacement datasets.

Step 2: Calculate the logarithm of the 3D intensity stacks under different incident illuminations and perform a 3D Fourier transform to obtain the 3D logarithmic intensity spectrum; then perform 3D half-space Fourier filtering or equivalently execute a 3D Hilbert transform on each logarithmic 3D intensity spectrum, obtaining 3D scattering fields containing real and imaginary parts of the complex phase function under different incident illuminations; next, in Fourier space synthesize all single-sideband 3D scattering fields to realize non-interferometric synthetic aperture, obtaining a preliminary estimate of the object's 3D scattering potential spectrum.

The specific implementation process is as follows: for volumetric imaging of 3D thick objects, the commonly used scattering potential function O(r) is employed to characterize the 3D structure of the sample. O(r) can be expanded into real and imaginary parts, which takes the form O(r)=a(r)+jϕ(r) where ϕ(r) and a(r) correspond to the phase component and absorption component of the scattering potential O(r).

The logarithm of the 3D intensity stack I(r) under different illumination conditions is taken and expressed as:

$$ln I ( r ) = a ( r ) ⊗ [ {g}^{′} ( r ) + {g}^{′ *} ( r ) ] + j ϕ ( r ) ⊗ [ {g}^{′} ( r ) - {g}^{′ *} ( r ) ] \qquad ( 7 )$$

where ϕ(r) and a(r) correspond to the phase and absorption components of the scattering potential O(r), respectively. g(r) and g′(r) represent the point spread function (PSF) of the tomographic imaging system and the PSF modulated by the incident illumination Uᵢₙ(r), respectively. g′*(r) is the conjugate form of g′(r).

By computing the Fourier transform of the above equation, the logarithmic intensity spectrum function is obtained as:

$$ln \hat{I} ( u ) = {H}_{a} ( u ) \hat{a} ( u ) + {H}_{ϕ} ( u ) \hat{ϕ} ( u ) \qquad ( 8 )$$

where Î(u), â(u) and \hat{ϕ}(u) correspond to the 3D Fourier transforms of the intensity stack I(r), the absorption component a(r), and the phase component ϕ(r) of the scattering potential O(r), respectively. Hₐ(u) and H_{ϕ}(u) are the absorption and phase transfer functions of the diffraction tomography imaging system.

Preferably, the absorption and phase transfer functions of the diffraction-tomography imaging system are expressed respectively as:

$${H}_{a} ( u ) = [ P ( u + {u}_{i n} ) + {P}^{*} ( u - {u}_{i n} ) ] \qquad ( 9 )$$

$${H}_{ϕ} ( u ) = j [ P ( u + {u}_{i n} ) - {P}^{*} ( u - {u}_{i n} ) ]$$

$$P ( u ) = P ( {u}_{T} ) δ ( {u}_{z} - \sqrt{{u}_{m}^{2} - {\vert {u}_{T} \vert}^{2}} )$$

where

$$P ( u ) = P ( {u}_{T} ) δ ( {u}_{z} - \sqrt{{u}_{m}^{2} - {\vert {u}_{T} \vert}^{2}} )$$

is the generalized coherent transfer function of the system, u=(u_{T}, u_{z}) is the spatial frequency coordinates corresponding to r, uₘ=nₘ/λ with nₘ being the refractive index of the medium surrounding the sample and λ the wavelength in free space. P*(u) is the complex conjugate of P(u), P(u+uᵢₙ) and P*(u−uᵢₙ) represent the phase transfer functions of P(u) and P*(u), respectively, after being laterally modulated by the incident spatial frequency uₘ.

Therefore, on the uₓ−u_{z} slice of the 3D logarithmic intensity spectrum, two anti-symmetric generalized apertures can be clearly observed; these apertures shift according to the incident-light angle and move mirror-symmetrically in 3D space, they never cancel each other, as shown in FIG. 4. Based on the positions of the two anti-symmetric generalized apertures in the spectrum, performing 3D half-space Fourier filtering or equivalently executing a 3D Hilbert transform on each bilateral 3D spectrum yields the single-sideband spectrum of the 3D scattering field U(r) containing the real and imaginary parts of the complex phase function under different incident illuminations.

According to the Fourier diffraction theorem

$$\hat{O} ( u - {u}_{i n} ) = 4 π {ju}_{z} {\hat{U}}_{s 1} ( {u}_{T} ) P ( {u}_{T} ) δ ( {u}_{z} - \sqrt{{u}_{m}^{2} - {\vert {u}_{T} \vert}^{2}} ) \qquad ( 10 )$$

In the Fourier domain, all single-sideband 3D scattering fields are synthesized to achieve non-interferometric synthetic aperture, yielding an initial estimate of the 3D scattering potential spectrum of the object. In the equation, u=(u_{T}, u_{z}) represents the spatial frequency coordinates corresponding tor, j is the imaginary unit, and Ô and Ûₛ₁ denote the Fourier transforms of O and U_{S1}, respectively. Ô(u−uᵢₙ) is the scattering potential spectrum of Ô(u) modulated by the spatial frequency uᵢₙ of the incident light, and

$$P ( {u}_{T} ) δ ( {u}_{z} - \sqrt{{u}_{m}^{2} - {\vert {u}_{T} \vert}^{2}} )$$

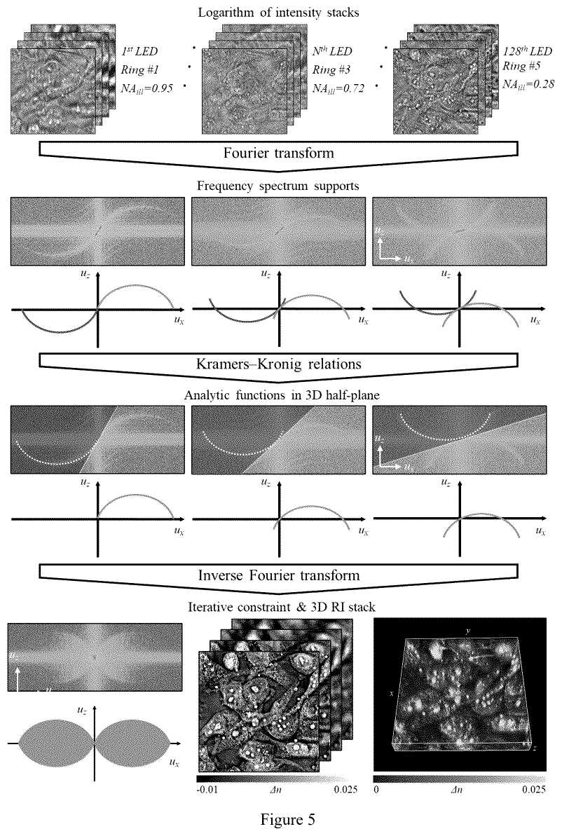

is the system's generalized coherent transfer function, whose finite support domain is called the Ewald sphere shell. As shown in FIG. 5, the reconstructed-data processing flow chart taking unstained MCF-7 cells as example is given.

Step 3: In order to compensate for the effects of LED-element discretization and partial coherence of illumination (temporal and spatial), the method further performs 3D deconvolution on the preliminarily synthesized spectrum based on LED discrete sampling, partial coherence of illumination, and a correction factor.

The specific implementation process is as follows: To compensate for the effects of LED-element discretization and partial coherence of illumination (temporal and spatial), the preliminarily synthesized spectrum is further subjected to 3D deconvolution; this deconvolution employs a transfer function that takes LED discrete sampling, partial coherence of illumination, and a correction factor into account, and the deconvolution process is expressed as:

$$\hat{O} ( u ) = \frac{{\hat{O}}_{syn} ( u ) {H}_{syn}^{*} ( u )}{{H}_{syn} ( u ) {H}_{syn}^{*} ( u ) + ε} \qquad ( 11 )$$

where Ô and Ô_{syn} are the finally deconvolved spectrum of object scattering potential and preliminary synthesized spectrum, respectively. H_{syn} is the synthesized 3D transfer function of the system. H*_{syn} is the conjugate form of H_{syn}, and ε is a small regularization parameter to prevent the over-amplification of noise.

The synthesized 3D transfer function of the system can be written as:

$${H}_{syn} ( {u}_{T} , {u}_{z} ) = \frac{j λ}{4 π} \int \int P ( {u}_{T}^{′} + {u}_{T} ) S ( {u}_{T}^{′} ) δ [ {u}_{z} + \sqrt{{λ}^{- 2} - {( {u}_{T}^{′} - {u}_{T} )}^{2}} ] {d}^{2} {u}_{T}^{′} \qquad ( 12 )$$

where j is the imaginary unit, λ is the wavelength of light in free space; P(u_{T}) is pupil function (i.e., 2D coherent transfer function), which ideally is a circ-function with a radius of NA_{obj}/λ; u=(u_{T}, u_{z}) is the spatial frequency coordinates corresponding to r; u_{T}=(uₓ, u_{y}) are the 2D spatial frequency coordinates, and S is the spatial frequency intensity distribution function of the light source.

Selecting and adding a regularization parameter aims to prevent excessive noise amplification during the deconvolution process. Experience shows that deconvolution performance depends largely on the choice of the regularization parameter, while the signal-to-noise ratio of the intensity stack also affects the final tomographic imaging quality. To prevent excessive noise amplification and ensure the refractive-index signal remains unchanged, the regularization parameters for dry objective and oil objective can be set around 0.1 and 0.25, respectively.

Step 4: Adopt a hybrid iterative constraint algorithm combining non-negative constraint and total-variation regularization to computationally fill the missing-cone information in the synthesized scattering-potential spectrum.

Specific implementation process is: based on prior knowledge of the sample, in the spatial domain the sample's refractive index is always considered higher than that of the medium, and the gradient value is taken as the optimization objective function, while in the frequency domain the experimentally measured spectrum data are regarded as true and valid. By imposing constraints simultaneously in the spatial domain and the frequency domain and iterating repeatedly, the missing-cone information in the scattering-potential spectrum can be filled to a certain extent, yielding more realistic results.

Step 5: Perform a 3D inverse Fourier transform on the finally synthesized 3D scattering-potential spectrum to restore the 3D refractive-index distribution of the specimen under test.

The specific implementation process is as follows: perform inverse Fourier transform on the 3D scattering-potential spectrum obtained in Step 5 to obtain the 3D scattering potential O(r). The sample scattering-potential function can also be expressed as

$$O ( r ) = {k}_{0}^{2} [ {n ( r )}^{2} - {n}_{m}^{2} ] ,$$

where n(r) is the 3D complex refractive-index distribution of the sample, k₀=2 π/λ is the wave vector in free space under illumination wavelength λ, and nₘ is the refractive index of the surrounding medium. According to

$$n ( r ) = \sqrt{\frac{1}{{k}_{0}^{2}} O ( r ) + {n}_{m}^{2}} \qquad ( 13 )$$

The complex refractive-index information of the specimen can thus be obtained, with its real part representing the refractive index and its imaginary part representing the absorption.

The present invention simultaneously employs a programmable LED array and a motorized stage. The LED array serves as the illumination source, ensuring programmable control of illumination patterns to deliver quasi-monochromatic plane-wave illumination at the required variable angles. The motorized stage, controlled via software and synchronized with the timing signals between the LED array and camera exposure, provides nanometer-level axial displacement of the specimen, enabling four-dimensional data acquisition of 3D intensity image stacks under various illumination angles. By applying 3D half-space filtering on the logarithmic intensity spectrum through the 3D spatial-domain Kramers-Kronig relation, complete information recovery (amplitude and phase) of the complex phase of the scattering field is achieved using intensity-only measurements. Combined with non-interferometric synthetic-aperture technology, first-order scattering fields acquired under different illumination angles are stitched together in the 3D spectral domain, achieving imaging resolution at the incoherent diffraction limit while rendering the imaging results immune to speckle and parasitic interference.

1. A method for transport of intensity diffraction tomography with non-interferometric synthetic aperture, characterized by the following steps:
Step 1: collect through-focus intensity stacks of the object under different illumination angles by turning on each LED element sequentially;
Step 2: calculate corresponding 3D spectra by taking 3D Fourier transform on the logarithmic intensity stack, by implementing the 3D half-space Fourier filtering on each logarithmic 3D intensity spectrum, the corresponding 3D scattered fields (containing real and imaginary parts of complex phase function) under different incident illuminations can be retrieved, the preliminary estimate of the 3D object spectrum can be further got by synthesizing 3D scattered fields together;
Step 3: perform 3D deconvolution on the initial estimated spectrum based on discrete LED sampling, partially coherent illumination, and correction factors;
Step 4: use a hybrid iterative constraint algorithm that combines non-negativity constraint and total variation regularization to computationally fill in the missing cone information in the synthesized scattering potential spectrum;
Step 5: perform a 3D inverse Fourier transform on the filled 3D scattering potential spectrum to reconstruct the 3D refractive index distribution of the sample, enabling label-free, non-invasive 3D imaging of biological specimens.

2. The method for transport of intensity diffraction tomography with non-interferometric synthetic aperture according to claim 1, characterized in that the through-focus intensity stacks of the object under different illumination angles are collected using a transport of intensity diffraction tomographic microscopy platform with non-interferometric synthetic aperture, the microscopy platform includes a programmable LED array, an electric focus stage device, samples, an objective lens, a tube lens, and a camera, the center of the programmable LED array is aligned with the optical axis of the imaging system, the back focal plane of the objective coincides with the front focal plane of the tube lens, and The imaging plane of the camera is positioned at the back focal plane of the tube lens; during imaging, the sample is placed on a motorized translation stage, the illuminating beam of each LED element is controlled to turn on sequentially, it passes through the sample with arbitrary tilted angles and falls on the imaging plane after concentrating by tube lens, by controlling the high-precision electric focus stage to scan the different focal planes, the through-focus intensity stacks can be recorded.

3. The method for transport of intensity diffraction tomography with non-interferometric synthetic aperture according to claim 1, characterized in that the logarithmic 3D intensity spectrum can be obtained by taking 3D Fourier transform on the logarithmic intensity stack under different illumination angles in step 2.

4. The method for transport of intensity diffraction tomography with non-interferometric synthetic aperture according to claim 1, characterized in that the scattering potential function O(r) is used to characterize the 3D structure of the sample, the scattering potential O(r) is expressed in terms of its real and imaginary parts, which is O(r)=a(r)+jϕ(r), where ϕ(r) and a(r) represent the phase and absorption parts of the scattering potential, respectively;
the logarithm of the 3D intensity stack under different illumination conditions is taken and expressed as:
$$ln I ( r ) = a ( r ) ⊗ [ {g}^{′} ( r ) - {g}^{′ *} ( r ) ] + j ϕ ( r ) ⊗ [ {g}^{′} ( r ) - {g}^{′ *} ( r ) ] \qquad ( 1 )$$
where ϕ(r) and a(r) correspond to the phase and absorption components of the scattering potential, respectively; g(r) and g′(r) represent the point spread function (PSF) of the tomographic imaging system and the PSF modulated by the incident illumination Uᵢₙ(r), respectively; g*(r) is the conjugate form of g′(r);
by computing the Fourier transform of the above equation, the logarithmic intensity spectrum function is obtained as:
$$ln \hat{I} ( u ) = {H}_{a} ( u ) \hat{a} ( u ) + {H}_{ϕ} ( u ) \hat{ϕ} ( u ) \qquad ( 2 )$$
where Î(u), â(u) and \hat{ϕ}(u) correspond to the 3D Fourier transforms of the intensity stack I(r), the absorption component a(r), and the phase component ϕ(r) of the scattering potential O(r), respectively. Hₐ(u) and H_{ϕ}(u) are the absorption and phase transfer functions of the diffraction tomography imaging system.

5. A non-interferometric synthetic aperture-based intensity transmission diffraction tomography imaging method according to claim 4, characterized in that the absorption and phase transfer functions of the diffraction tomography imaging system are respectively expressed
$${H}_{a} ( u ) = [ P ( u + {u}_{i n} ) + {P}^{*} ( u - {u}_{i n} ) ] \qquad ( 3 )$$
$${H}_{ϕ} ( u ) = j [ P ( u + {u}_{i n} ) - {P}^{*} ( u - {u}_{i n} ) ]$$
$$where P ( u ) = P ( {u}_{T} ) δ ( {u}_{z} - \sqrt{{u}_{m}^{2} - {\vert {u}_{T} \vert}^{2}} )$$
is the generalized coherent transfer function of the system, u=(u_{T}, u_{z}) is the spatial frequency coordinates corresponding to r, uᵢₙ=nᵢₙ/λ with nm being the refractive index of the medium surrounding the sample and λ the wavelength in free space; P*(u) is the complex conjugate of P(u), P(u+uᵢₙ) and P*(u−uᵢₙ) represent the phase transfer functions of P(u) and P*(u), respectively, after being laterally modulated by the incident spatial frequency uᵢₙ.

6. A non-interferometric synthetic aperture-based intensity transmission diffraction tomography imaging method according to claim 4, characterized in that each logarithmic intensity spectrum is subjected to 3D half-space Fourier filtering or a 3D Hilbert transform to obtain 3D scattering fields under different illumination conditions, containing both the real and imaginary parts of the complex phase function; these single-sideband 3D scattering fields are then synthesized in the Fourier domain to achieve non-interferometric synthetic aperture, yielding an initial estimate of the 3D scattering potential spectrum of the sample; the specific process is as follows.
According to the positions of the two antisymmetric generalized apertures in the spectrum, each double-sideband 3D spectrum is processed using 3D half-space Fourier filtering or a 3D Hilbert transform to obtain the 3D scattering field Uₛ₁(r) under different illumination conditions, which contains both the real and imaginary parts of the complex phase function; this is based on the Fourier diffraction theorem;
$$\hat{O} ( u - {u}_{i n} ) = 4 π {ju}_{z} {\hat{U}}_{s 1} ( {u}_{T} ) P ( {u}_{T} ) δ ( {u}_{z} - \sqrt{{u}_{m}^{2} - {\vert {u}_{T} \vert}^{2}} ) \qquad ( 4 )$$
in the Fourier domain, all single-sideband 3D scattering fields are synthesized to achieve non-interferometric synthetic aperture, yielding an initial estimate of the 3D scattering potential spectrum of the object; in the equation, u=(u_{T}, u_{z}) represents the spatial frequency coordinates corresponding to r, j is the imaginary unit, and Ô and Ûₛ₁ denote the Fourier transforms of O and U_{S1},respectively; Ô(u−uᵢₙ) is the scattering potential spectrum of Ô(u) modulated by the spatial frequency um of the incident light, and
$$P ( {u}_{T} ) δ ( {u}_{z} - \sqrt{{u}_{m}^{2} - {\vert {u}_{T} \vert}^{2}} )$$
is the system's generalized coherent transfer function, whose finite support domain is called the Ewald sphere shell.

7. According to the interference-free synthetic aperture-based intensity transport diffraction tomography microscopy method as claimed in claim 1, wherein the deconvolution process in step 3 is expressed as:
$$\hat{O} = \frac{{\hat{O}}_{syn} {H}_{syn}^{*}}{{H}_{syn} {H}_{syn}^{*} + ε} \qquad ( 5 )$$
where Ô and Ô_{syn} are the finally deconvolved spectrum of object scattering potential and preliminary synthesized spectrum, respectively, H_{syn} is the synthesized 3D transfer function of the system;
$${H}_{syn}^{*}$$
is the conjugate form of H_{syn}, and ε is regularization parameter.

8. According to the interference-free synthetic aperture intensity transport diffraction tomography microscopy method as claimed in claim 7, wherein the three-dimensional incoherent transfer function of the system after synthetic aperture processing is specifically:
$${H}_{syn} ( {u}_{T} , {u}_{z} ) = \frac{j λ}{4 π} \int \int P ( {u}_{T}^{′} + {u}_{T} ) S ( {u}_{T}^{′} ) δ [ {u}_{z} + \sqrt{{λ}^{- 2} - {( {u}_{T}^{′} - {u}_{T} )}^{2}} ] {d}^{2} {u}_{T}^{′} \qquad ( 6 )$$
where j is the imaginary unit, λ is the illumination wavelength in free space, P(u_{T}) represents the objective pupil function, that is, the two-dimensional coherent transfer function, which ideally is a circular function with a radius of NA_{obj}/λ, determined by the numerical aperture NA_{obj} of the objective, u=(u_{T}, u_{z}) is the spatial frequency coordinate corresponding to r, u_{T}=(uₓ, u_{y}) is the two-dimensional spatial frequency coordinate, and S is the spatial frequency intensity distribution function of the illumination source.

9. The method for transport of intensity diffraction tomography with non-interferometric synthetic aperture according to claim 3, characterized in that the scattering potential function O(r) is used to characterize the 3D structure of the sample, the scattering potential O(r) is expressed in terms of its real and imaginary parts, which is O(r)=a(r)+jϕ(r), where ϕ(r) and a(r) represent the phase and absorption parts of the scattering potential, respectively;
the logarithm of the 3D intensity stack under different illumination conditions is taken and expressed as:
$$ln I ( r ) = a ( r ) ⊗ [ {g}^{′} ( r ) - {g}^{′ *} ( r ) ] + j ϕ ( r ) ⊗ [ {g}^{′} ( r ) - {g}^{′ *} ( r ) ] \qquad ( 1 )$$
where ϕ(r) and a(r) correspond to the phase and absorption components of the scattering potential, respectively; g(r) and g′(r) represent the point spread function (PSF) of the tomographic imaging system and the PSF modulated by the incident illumination Uᵢₙ(r), respectively; g*(r) is the conjugate form of g′(r);
by computing the Fourier transform of the above equation, the logarithmic intensity spectrum function is obtained as:
$$ln \hat{I} ( u ) = {H}_{a} ( u ) \hat{a} ( u ) + {H}_{ϕ} ( u ) \hat{ϕ} ( u ) \qquad ( 2 )$$
where Î(u), â(u) and \hat{ϕ}(u) correspond to the 3D Fourier transforms of the intensity stack I(r), the absorption component a(r), and the phase component ϕ(r) of the scattering potential O(r), respectively. Hₐ(u) and H_{ϕ}(u) are the absorption and phase transfer functions of the diffraction tomography imaging system.
